(19) United States
(12) Patent Application Publication
(10) Pub. No.: US 2026/0047985 A1
(43) Pub. Date: Feb. 19, 2026

(54) MULTI-FUNCTION PACIFIER ASSEMBLY

(71) Applicants: Kiyle Gardner, Havana, FL (US); Bradley Abbott, Crowley, TX (US)

(72) Inventors: Kiyle Gardner, Havana, FL (US); Bradley Abbott, Crowley, TX (US)

(21) Appl. No.: 19/298,718

(22) Filed: Aug. 13, 2025

Related U.S. Application Data
(60) Provisional application No. 63/682,410, filed on Aug. 13, 2024.

(51) Int. Cl. A61J 17/02; A61J 9/00; A61J 9/06; A61J 11/00; A61J 17/00

(52) U.S. Cl. CPC A61J 17/02; A61J 9/008; A61J 9/0607; A61J 11/008; A61J 17/1011; A61J 17/1115

(57) ABSTRACT

A multifunctional nutritional pacifier system is provided for delivering nutrients to an infant while also offering teething and sensory features. The system includes a nutrient delivery assembly having a nipple extending from a guard shield and a nutrient pod interface on the backside of the shield, with a piercing member for rupturing a sealed pod. A rear cap secures the pod for controlled release of nutrient gel through pinholes in the nipple during sucking. A flexible silicone bridge connects the nutrient delivery assembly to a teether toy assembly, which includes a luminescent, chewable ring with a hollow interior containing solid rattle objects. The bridge may include a molded reservoir for storage. A protective cover is also provided to enclose the nipple when not in use. The integrated system enhances infant nutrition, engagement, and hygiene in a unified, portable assembly.

### REFERENCE TO RELATED APPLICATIONS

This application is a non-provisional application that claims the benefit of U.S. provisional patent application No. 63/682,410 filed Aug. 13, 2024 and titled Multi-Function Pacifier Assembly which claims the benefit of U.S. patent application Ser. No. 29/928,512 filed on Feb. 13, 2024 and titled Nutrient Delivery Pacifier and further claims the benefit of application Ser. No. 18/449,853 filed Aug. 15, 2023 (now U.S. Pat. No. 11,903,903) titled Multi-Function Pacifier Assembly, which claims the benefit of provisional patent application Ser. No. 63/397,998 filed Aug. 15, 2022 and titled Multi-Function Pacifier Assembly, which is incorporated herein in its entirety.

### BACKGROUND OF THE INVENTION

This invention relates generally to pacifiers and, more particularly, to a multi-function pacifier assembly having an interchangeable nipple, entertainment and developmental accessories, and a glow-in-the-dark teething and rattle toy so as to be useful throughout a toddler's early development years.

Traditional pacifiers are used primarily to placate or, literally, to pacify an infant or toddler for a period of time to keep them from crying and, as a result, to enable the child's caregivers to attend to other tasks. If properly utilized and configured, however, a pacifier can be so much more than just a convenience. As will be described below, there are deficiencies and developmental issues met by other devices that could be handled more efficiently with a properly configured and multi-functional pacifier assembly.

The UN estimates that around 385,000 babies are born each day around the world (140 million a year). There are approximately 10,687 babies born per day and 3,000,750 babies born each year in the United States alone. Newborn babies, until they reach 1 year in age are very likely to use pacifiers. The baby pacifier market size was valued at $352.2 million in 2018 and is expected to reach $522.6 million by 2026.

The CDC estimates only 5% to 13% of breastfed infants and 20% to 37% of formula-fed babies are getting enough vitamin D to meet the new guidelines. This astonishing statistic reveals that an astronomical number of babies are born without enough vitamins in their system. Later on, the newborn child needs around 500 milligrams of calcium each day. Vitamins A, B, C, D, E, and K are also significant supporters of a child's healthy development and growth.

Baby pacifiers, even with their high association with a baby's life, are underutilized for their usefulness. Parents of newborn children constantly need to spend additional dollars and invest time to meet additional needs in a baby's daily life-entertaining the child, providing essential nutrients to the child, pacifying the child etc. Moreover, pacifier makers are almost always limited to selling a few pacifiers in each baby's lifetime with not much recognition of the value because of the existing revenue model. The first distinguishable pacifier was patented in 1901 by Christian W. Meinecke who referred to it as the “Baby Comforter.” For decades, the pacifier has maintained the same design and purpose without any major innovation to revolutionize the baby market and offer more benefits to its consumers.

Although a traditional pacifier is presumably effective for its intended purposes, it is still inadequate to meet the nutritional and developmental needs of an infant and the convenience needed by parents or caregivers.

Therefore, it would be desirable to have a multi-functional pacifier assembly to keep the baby preoccupied while providing entertainment and nutritional benefits. Further, it would be desirable to have a multi-functional pacifier assembly that provides nutritional delivery technology, a glow-in-the-dark teething and rattle assembly (so that the invention never becomes lost in the dark), and may even include pre-recorded caregiver voices or music.

### SUMMARY OF THE INVENTION

A multifunctional pacifier system includes a guard shield having winged extensions shaped to conform to an infant's cheeks for added comfort and graspability, The nipple extends from a front side of the guard shield, while a recessed interface on the backside receives the nutrient pod and includes a piercing member to rupture the foil seal of the pod. A rear cap secures the pod in place and may provide a complementary attachment point for the bridge member.

The teether toy assembly includes a ring with a hollow interior that holds multiple solid elements, such as pebbles or other rattle components. The ring is made of a chewable elastomeric material and is coupled to the nutrient delivery assembly via a flexible bridge. A protective dome-shaped cover may also be provided to enclose the nipple when not in use, thereby preserving hygiene.

Accordingly, the present invention provides a compact, multifunctional infant care system that streamlines the delivery of nutrition, enhances sensory engagement, and improves parental convenience—all in a single, easy-to-use assembly.

A primary object of the present invention is to provide a pacifier system that enables the controlled delivery of nutrient gel or liquid to an infant in a convenient and sanitary manner. The invention achieves this by incorporating a replaceable nutrient pod into a nipple-based pacifier that dispenses nutrients through one or more pinholes in response to a sucking action of the infant.

Another object of the invention is to combine the functions of a pacifier, a baby rattle, and a teething toy into a single integrated apparatus. The invention includes a teether toy assembly that provides tactile stimulation and soothing relief during teething, while also producing sound when shaken to entertain or engage the infant.

Yet another object of the invention is to provide a bridge member that securely connects the nutrient delivery assembly to the teether toy assembly, thereby maintaining the components as a unified system and minimizing loss or separation. The bridge member may include a molded or extruded reservoir for additional storage and may be flexible and durable enough to withstand infant handling.

A further object is to improve nighttime usability by constructing at least a portion of the teether toy assembly from a luminescent material. This glow-in-the-dark feature makes it easier for caregivers to locate the pacifier in a dark room or crib without disturbing the infant.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a multi-functional pacifier assembly according to a preferred embodiment of the present invention;

FIG. 1b is a top view of the pacifier assembly as in FIG. 1a;

FIG. 1c is a sectional view taken along lines 1c-1c of FIG. 1b;

FIG. 1d is a perspective view of a piercing member according to the present invention;

FIG. 2a is a perspective view of a teether toy assembly removed from the pacifier assembly of FIG. 1a;

FIG. 2b is an exploded view of the teether assembly illustrated in FIG. 2a;

FIG. 3 is an isolated view of a bridge assembly removed from the pacifier assembly illustrated in FIG. 1a;

FIG. 4a is a perspective view from a top-down angle of the nipple portion of the pacifier assembly;

FIG. 4a is a perspective view from a rear-up angle of the nipple portion of the pacifier assembly;

FIG. 4c is a side view of the nipple as illustrated in FIG. 4a;

FIG. 4d is a sectional view taken along line 4d-4d of FIG. 4c;

FIG. 5 is a perspective view of an accessory ring taken from the pacifier assembly as in FIG. 1a;′

FIG. 6 is an isolated perspective view of a sanitary cap according to the present invention;

FIG. 7a is a perspective view of the nutrient delivery subassembly according to the present invention;

FIG. 7b is a side view of the nutrient delivery subassembly as in FIG. 7a;

FIG. 7c is a sectional view taken along line 7c-7c of FIG. 7b;

FIG. 7d is another side view of the nutrient delivery subassembly as in FIG. 7a;

FIG. 7e is a rear view of the nutrient delivery subassembly as in FIG. 7a

FIG. 7f is an exploded view of the nutrient delivery subassembly as in FIG. 7e;

FIG. 8a is a perspective view of a nutrient pod isolated and removed from the nutrient delivery subassembly according to the present invention;

FIG. 8b is a side view of the nutrient pod is in FIG. 8a;

FIG. 8c is a sectional view taken along line 8c-8c of FIG. 8b;

FIG. 8d is a perspective view from a lower angle of the nutrient pod as in FIG. 8a;

FIG. 8e is an isolated view of the nutrient pod as in FIG. 8a, illustrated with the foil seal removed;

FIG. 9a is an isolated perspective view of a rear cap of the nutrient delivery subassembly according to the present invention; and

FIG. 9b is another perspective view from a rear angle of the rear angle as in FIG. 9a.

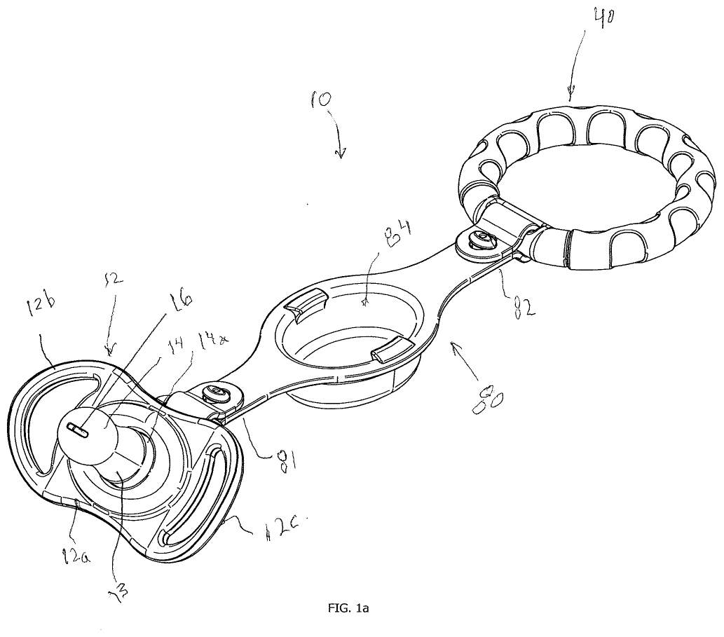

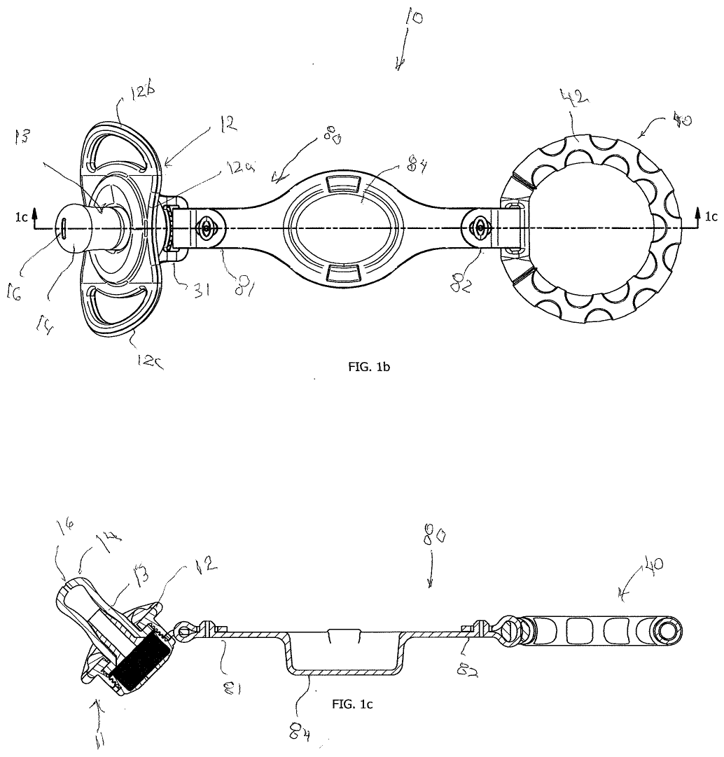

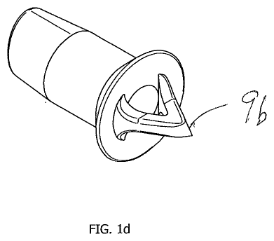

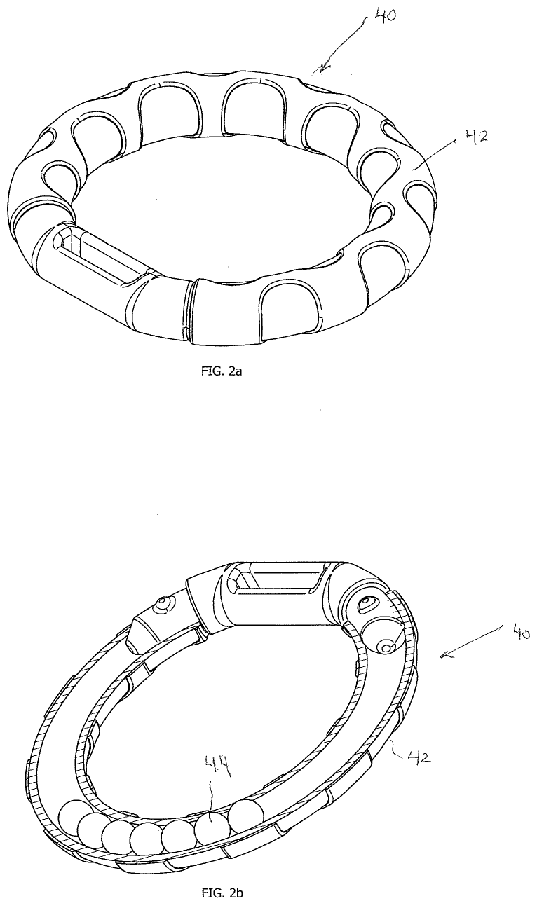

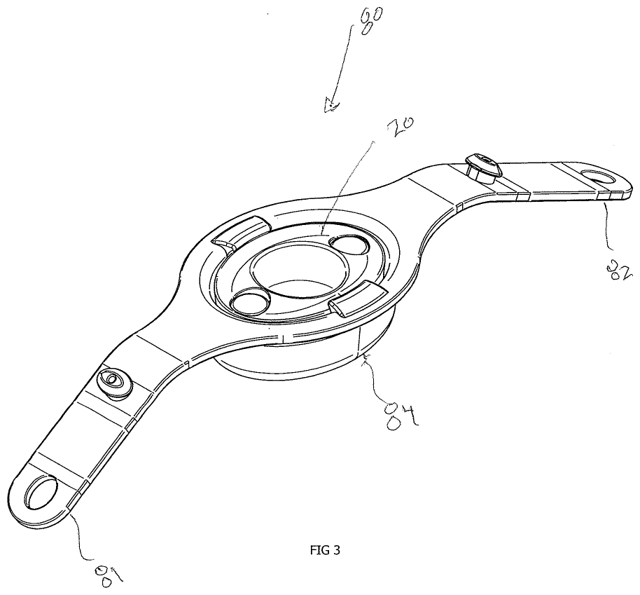

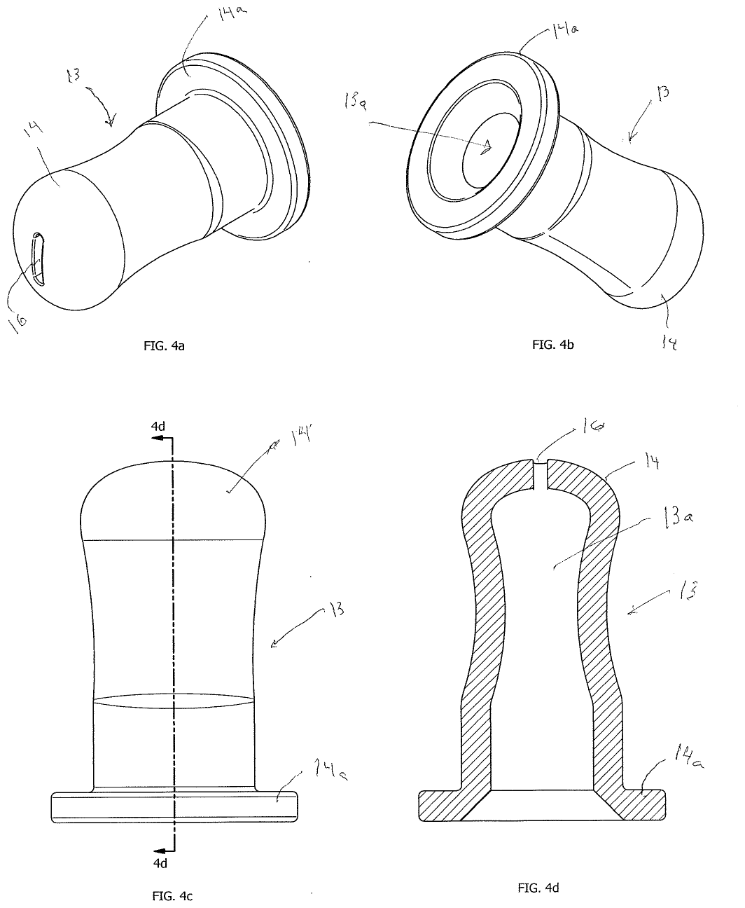

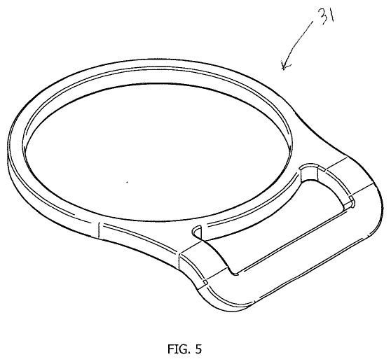

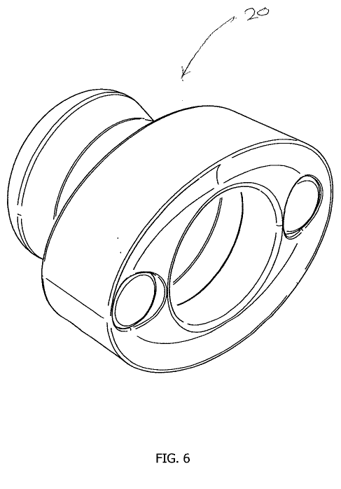

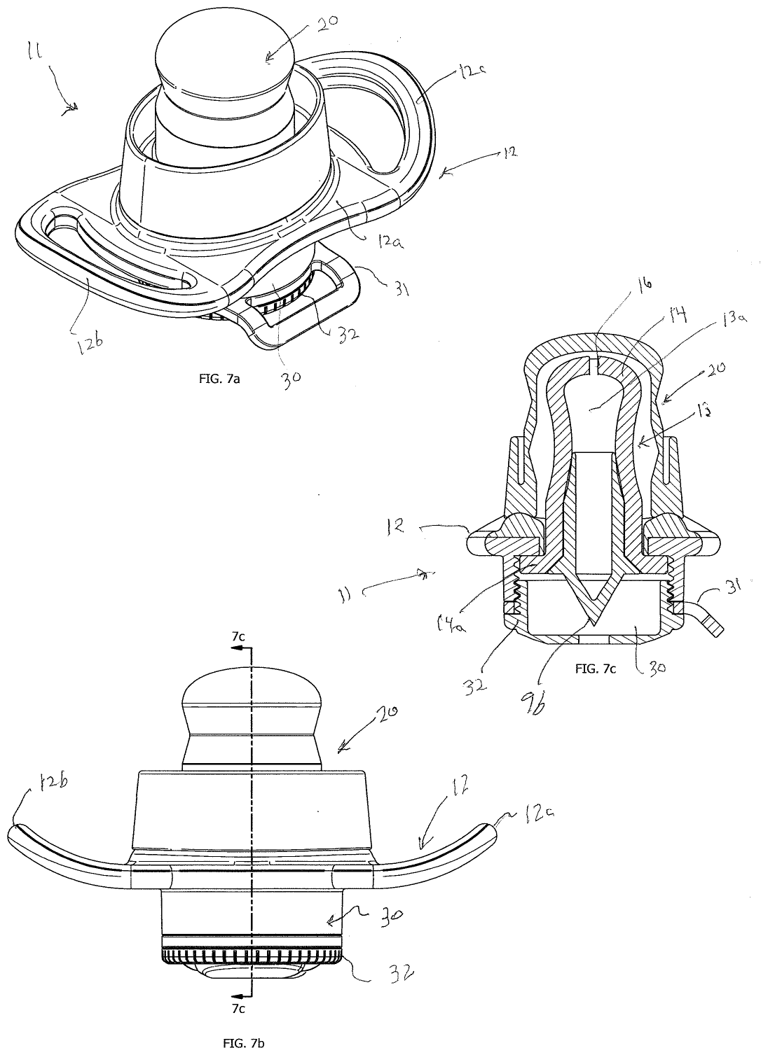

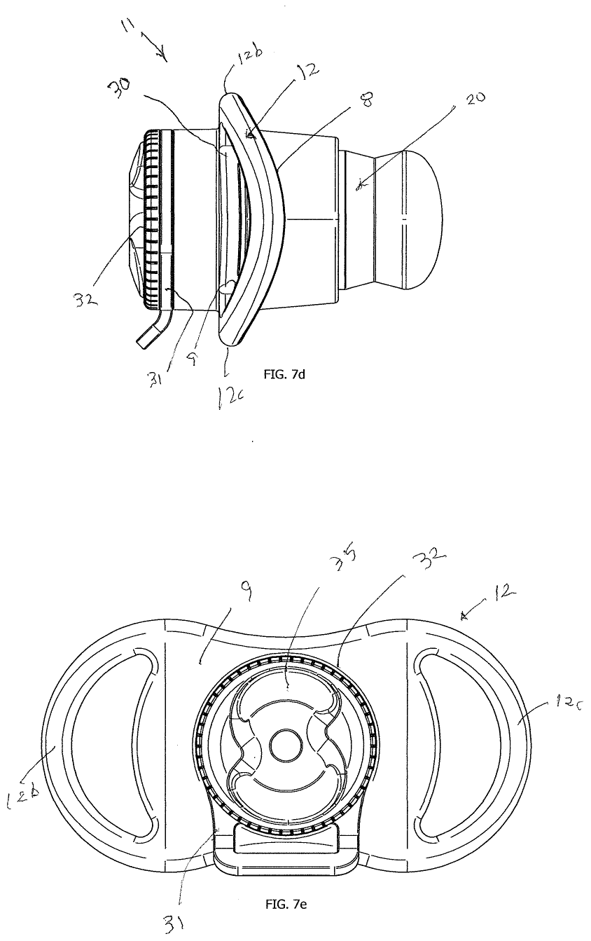

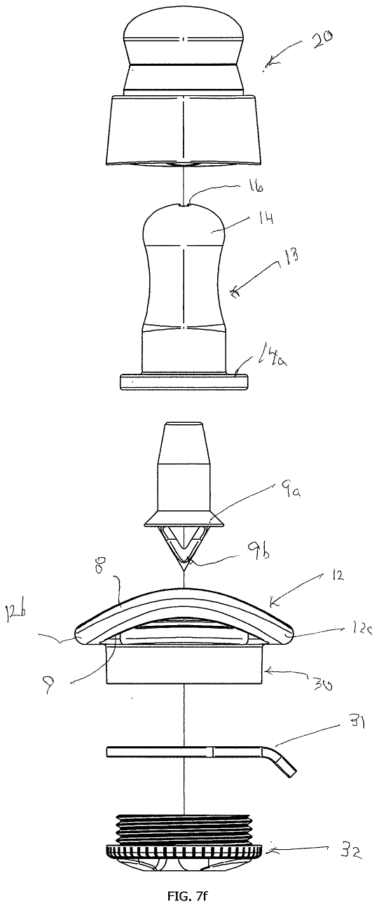

### DESCRIPTION OF THE PREFERRED EMBODIMENT

Referring now to the drawings, wherein like reference numerals designate corresponding parts throughout the several views, a preferred embodiment of a nutritional pacifier system 10 is disclosed. The pacifier system 10 is a multifunctional device configured to deliver nutrients to an infant while simultaneously serving as a teething aid and sensory toy,

The pacifier system 10 broadly includes three primary subassemblies: a nutrient delivery assembly 11, an accessory teething assembly 40, and a bridge member 80 operatively coupling the two. Each subassembly will be described below in more detail.

The nutrient delivery assembly 11 includes a guard shield 12 and a nipple 13 projecting outwardly from a front side 8 of the guard shield. The nipple 13 may have an elongate sidewall that defines an inner channel 13a (also referred to as an interior passage 13a) and may include a bulbous portion 14 extending away from a mounting portion 14a that connects to the guard shield 12. The bulbous portion 14 preferably has a generally spherical or rounded shape that facilitates sucking by an infant. In a preferred embodiment, the bulbous portion 14 defines one or more pinholes 16 to allow nutrient gel or liquid to be drawn through the nipple during use.

The guard shield 12 comprises a central section 12a and opposing wing sections 12b and 12c extending laterally outward. These wing sections may have a curved or inwardly concave configuration to contour to the cheeks of the infant, improving comfort during use. One or both wing sections may also define an opening to facilitate grasping of the pacifier by a caregiver or the infant using a single finger and thumb.

On a backside 9 of the guard shield 12, a recessed interface 9a is formed for receiving a nutrient pod 30. More particularly, a nutrient pod 30 may include a bottom wall, upstanding sidewalls, and a foil seal that, together, define an interior space for holding the nutrient gel. The interface 9a includes an integrated piercing member 9b adapted to puncture the foil seal on the nutrient pod 30 when it is inserted. The interface 9a is also in fluid communication with the interior passage 13a defined by and extending through the nipple 13 such that nutrient gel flows from the pod into the nipple bulb when suction is applied (such as by an infant).

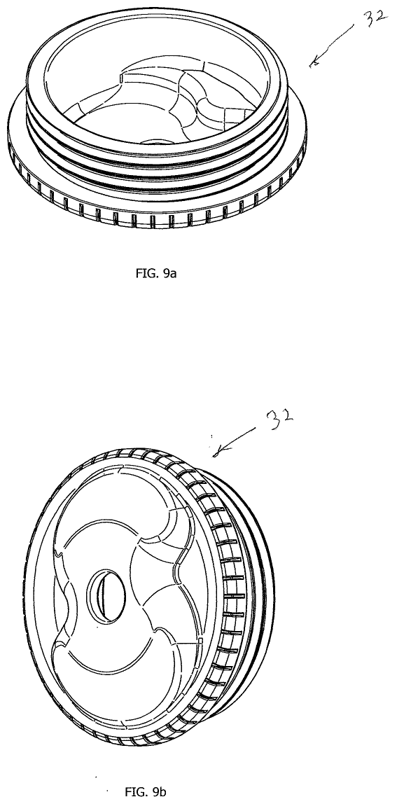

To secure the nutrient pod 30 in place, a rear cap 32 is provided (FIG. 9a). The rear cap 32 is configured to press the nutrient pod 30 firmly into the interface 9a, ensuring contact with the piercing member 9b and enabling nutrient flow. The rear cap 32 may be friction-fit or threadably and removably secured to the backside 9 of the guard shield 12. In one embodiment, the rear cap 32 further includes an accessory ring 31 having a fastener feature that is complementary to a coupling element on a first end 81 of the bridge member 80.

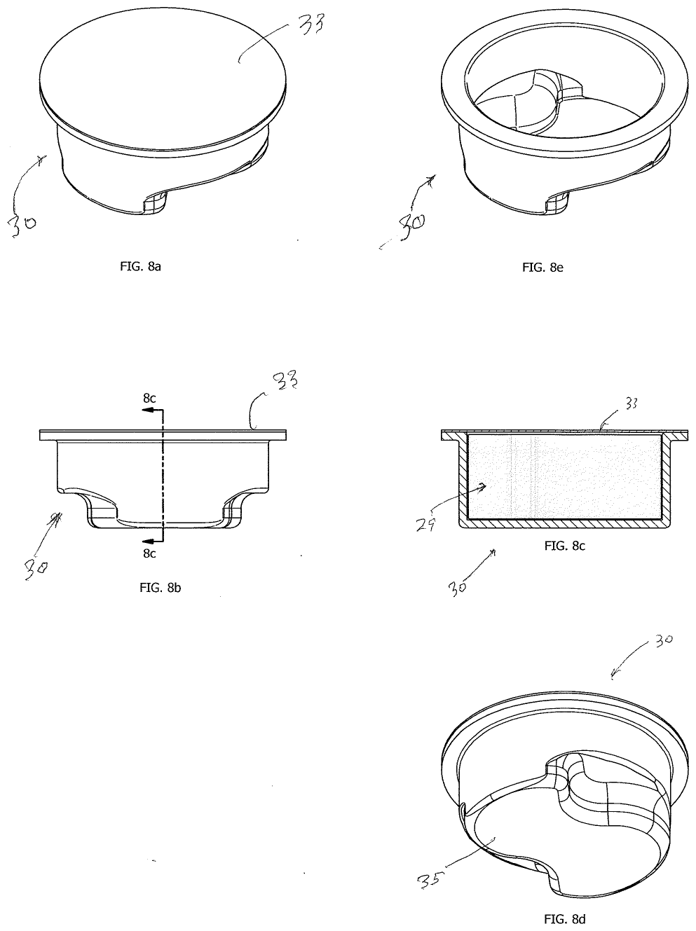

The nutrient pod 30 may include a bottom wall and upstanding/continuous sidewall that, together, define an open top and open interior area that may be prefilled with a predetermined quantity of nutrient gel 29 or liquid, sealed with the foil cover 33 (FIG. 8c), and is intended to be disposable and replaceable, in the manner of other baby food delivery mechanisms. In some embodiments, the nutrient pod 30 and the interface 9a may include complementary proprietary shapes that allow for secure nesting or locking engagement. For instance, each structure may include an S-shape (either a recess or protrusion 35, respectively) designed to enhance proper alignment with the piercing member 9b as well as to provide proprietary brand identification (FIG. 8d).

A bridge member 80 extends between the nutrient delivery assembly 11 and the accessory teething assembly 40. More particularly, the bridge member 80 is preferably an elongate, flexible strap constructed from silicone or a similar durable, elastic material. The bridge member includes a first end 81 coupled to the central section 12a of the guard shield 12, and a second end 82 coupled to the teether toy assembly 40.

In a preferred embodiment, the bridge member 80 may be molded or extruded to include a reservoir 84, which defines an open cavity or storage area located intermediate the first and second ends 81, 82. This reservoir 84 may be used to store small objects or utility items, such as a pacifier clip or medicine sachet. Optionally, the bridge member 80 may include a cover flap that selectively seals or covers the reservoir 84, providing secure containment of the stored item. The teether toy assembly 40 is configured to function both as a chewable teether and as a baby rattle. It includes a ring 42 having a generally circular outer profile and a hollow interior defined by a continuous wall. The ring 42 is preferably constructed from a thermoplastic elastomeric material suitable for oral use and teething activity.

The hollow interior of the ring 42 may contain a plurality of solid objects 44, such as small rocks, pebbles, seeds, bone fragments, or semi-precious stones, which move freely inside the ring to produce a rattle effect when shaken. This tactile and auditory feedback provides a stimulating experience for the infant during play and teething.

A critical feature of the ring 42 is that it is constructed of, or coated with, a luminescent material. Specifically, the wall of the ring 42 may be treated with photoluminescent ink containing a phosphor, which glows in the dark after being exposed to light. This phosphor-based ink may be water-based and non-toxic, making it suitable for infant use. Preferably, the luminescence is green, as phosphor glows green more intensely and for longer durations compared to other colors. The glow helps caregivers locate the pacifier system 10 in dark environments, such as a crib or nursery at night. In still another embodiment, the bridge member 80 may be constructed of luminescent material in a manner substantially similar as that described above.

To ensure hygiene when the pacifier system 10 is not in use, a protective cover 20 is provided. The cover 20 includes a domed outer wall that defines a hollow interior space dimensioned to receive the nipple 13. The cover 20 is configured to be removably coupled to the front side 8 of the guard shield 12 to enclose the nipple 13 in a sanitary manner during transport or storage. In an embodiment, the cover 20 may include multiple walls arranged in a stairstep and telescopic configuration that may be compressed and stored (such as in reservoir 84) when not in use.

It is understood that while certain forms of this invention have been illustrated and described, it is not limited thereto except insofar as such limitations are included in the following claims and allowable functional equivalents thereof.

1. A nutritional pacifier system, comprising:
a nutrient delivery assembly including:
a guard shield having a front side and a backside;
a nipple having a mounting portion coupled to the front side of the guard shield and a body portion extending away from the front side and that defines an interior passage, the nipple having a bulbous portion defining at least one pinhole in fluid communication with the interior passage,
a nutrient pod having a continuous lower wall and a frangible cover that, together, define an interior area configured to contain a nutritional gel;
an interface formed on the backside of the guard shield that is configured to removably receive said nutrient pod in a nested engagement, the interface including a piercing member for piercing the frangible cover of the nutrient pod, said interface being in fluid communication with the interior passage of the nipple;
a teether toy assembly including a ring including (1) an outer surface having a circular configuration and defining an interior that is hollow and (2) a plurality of solid objects situated in said hollow interior each being unattached so as to make a rattling sound when said ring is shaken;
a bridge member extending between the nutrient delivery assembly and the teether toy assembly, the bridge member comprising a silicone strap having an elongate configuration that includes a first end coupled to the guard shield and a second end coupled to the teether toy assembly.

2. The nutritional pacifier system as in claim 1, wherein the nutritional delivery system includes a rear cap releasably coupled to the backside of the guard shield and configured to press the nutrient pod into the interface.

3. The nutritional pacifier system as in claim 1, wherein the ring is constructed of a luminescent material so as to glow-in-the-dark.

4. The nutritional pacifier system as in claim 1, wherein the ring is constructed of a chewable, elastomeric material.

5. The nutritional pacifier system as in claim 1, wherein said guard shield includes a central section having a generally planar configuration and a pair of wing sections extending away from opposing lateral edges of said central section at an inwardly concave angle.

6. The nutritional pacifier system as in claim 1, wherein the bridge member includes a storage reservoir that defines an interior space and a flap that is movable between a closed configuration that blocks access to the interior space and an open configuration that allows access to the interior space.

7. The nutritional pacifier system as in claim 1, wherein said solid objects include one or more of rocks, pebbles, seeds, precious stones, or bone fragments.

8. The nutritional pacifier system as in claim 3, wherein the outer surface of the ring is coated or impregnated with photoluminescent ink that includes phosphor that emits visible light after exposure to a light source.

8. The nutritional pacifier system as in claim 1, wherein the rear cap includes a fastener that is complementary to the first end of said bridge member.

10. The nutritional pacifier system as in claim 1 further comprising a protective cover configured for placement over the nipple so as to maintain sanitation when not in use.

11. The nutritional pacifier system as in claim 1, wherein the nutrient pod and the interface define complementary nesting geometries configured to lock the nutrient pod in place when inserted.

12. A nutritional pacifier system, comprising:
a nutrient delivery assembly including:
a guard shield having a front side and a backside;
a nipple having a mounting portion coupled to the front side of the guard shield and a body portion extending away from the front side and that defines an interior passage, the nipple having a bulbous portion defining at least one pinhole in fluid communication with the interior passage,
a nutrient pod having a continuous lower wall and a frangible cover that, together, define an interior area configured to contain a nutritional gel;
an interface formed on the backside of the guard shield that is configured to removably receive said nutrient pod in a nested engagement, the interface including a piercing member for piercing the frangible cover of the nutrient pod, said interface being in fluid communication with the interior passage of the nipple;
a rear cap releasably coupled to the backside of the guard shield and configured to press the nutrient pod into the interface;
a teether toy assembly including a ring having (1) an outer surface coated or impregnated with photoluminescent ink so as to glow-in-the-dark and having a circular configuration defining an interior that is hollow and (2) a plurality of solid objects situated in said hollow interior each being unattached so as to make a rattling sound when said ring is shaken;
a bridge member extending between the nutrient delivery assembly and the teether toy assembly, the bridge member comprising a silicone strap having an elongate configuration that includes a first end coupled to the guard shield and a second end coupled to the teether toy assembly.

13. The nutritional pacifier system as in claim 12, wherein the ring is constructed of a chewable, elastomeric material.

14. The nutritional pacifier system as in claim 12, wherein said guard shield includes a central section having a generally planar configuration and a pair of wing sections extending away from opposing lateral edges of said central section at an inwardly concave angle.

15. The nutritional pacifier system as in claim 12, wherein the bridge member includes a storage reservoir that defines an interior space and a flap that is movable between a closed configuration that blocks access to the interior space and an open configuration that allows access to the interior space.

16. The nutritional pacifier system as in claim 12, wherein said solid objects include one or more of rocks, pebbles, seeds, precious stones, or bone fragments.

17. The nutritional pacifier system as in claim 12, wherein the nutrient pod and the interface define complementary nesting geometries configured to lock the nutrient pod together when inserted.

18. A method of delivering nutrients to an infant using a nutritional pacifier system, the method comprising:
inserting a nutrient pod into an interface located on a backside of a guard shield of a nutrient delivery assembly;
coupling a rear cap to the backside of the guard shield to press the nutrient pod into engagement with a piercing member formed within the interface;
puncturing a foil cover of the nutrient pod with the piercing member; and
allowing nutrient gel from the nutrient pod to pass through an interior passage and exit through at least one pinhole defined in a bulbous portion of a nipple extending from a front side of the guard shield, in response to a sucking action by the infant.

19. The method as in claim 18, further comprising providing a teether toy assembly having a luminescent ring constructed of an elastomeric material and configured for chewing by the infant.

20. The method of claim 19, further comprising attaching opposed ends of an elongate strap to the nutrient delivery assembly and to a teether toy assembly, respectively.
